(19) United States
(12) Patent Application Publication
(10) Pub. No.: US 2007/0097962 A1
(43) Pub. Date: May 3, 2007

(54) METHOD AND APPARATUS FOR DETERMINING THE MAXIMUM TRANSMIT POWER OF A MOBILE TERMINAL

(75) Inventors: Young C. Yoon, San Diego, CA (US); Li-Hsiang Sun, San Diego, CA (US); Suk Woo Lee, San Diego, CA (US)

Correspondence Address: JONATHAN Y. KANG, ESQ.;LEE, HONG, DEGERMAN, KANG & SCHMADEKA, P.C., 12th Floor, 801 S. Figueroa Street, Los Angeles, CA, 90017-5554, US

(73) Assignee: LG Electronics Inc.

(21) Appl. No.: 11/556,105

(22) Filed: Nov. 2, 2006

Related U.S. Application Data
(60) Provisional application No. 60/733,422, filed on Nov. 3, 2005.

(51) Int. Cl. H04L 12/66

(52) U.S. Cl. 370/352; 370/395.21

(57) ABSTRACT

A method and apparatus is provided to enable a network to more efficiently determine whether additional reverse links can be assigned. Various methods are presented that allow a network to determine either the transmission power or power headroom of a mobile terminal based on information that is provided at session startup and information provided periodically. The number of additional reverse links that can be assigned to the mobile can then be estimated from the transmission power and headroom of the mobile terminal.

### CROSS-REFERENCE TO RELATED APPLICATIONS

Pursuant to 35 U.S.C. § 119(a), this application claims the benefit of U.S. Provisional Application Ser. No. 60/733,422 filed on Nov. 3, 2005, the contents of which is hereby incorporated by reference herein in its entirety.

### FIELD OF THE INVENTION

The invention is related to a method and apparatus to enable a network to more efficiently determine the transmission power of a mobile terminal.

### DESCRIPTION OF THE RELATED ART

In the world of cellular telecommunications, those skilled in the art often use the terms 1G, 2G, and 3G. The terms refer to the generation of the cellular technology used. 1G refers to the first generation, 2G to the second generation, and 3G to the third generation.

1G refers to the analog phone system, known as an AMPS (Advanced Mobile Phone Service) phone systems. 2G is commonly used to refer to the digital cellular systems that are prevalent throughout the world, and include CDMAOne, Global System for Mobile communications (GSM), and Time Division Multiple Access (TDMA). 2G systems can support a greater number of users in a dense area than can 1G systems.

3G commonly refers to the digital cellular systems currently being deployed. These 3G communication systems are conceptually similar to each other with some significant differences.

Referring to FIG. 1, a wireless communication network architecture 1 is illustrated. A subscriber uses a mobile station (MS) 2 to access network services. The MS 2 may be a portable communications unit, such as a hand-held cellular phone, a communication unit installed in a vehicle, or a fixed-location communications unit.

The electromagnetic waves for the MS 2 are transmitted by the Base Transceiver System (BTS) 3 also known as node B. The BTS 3 consists of radio devices such as antennas and equipment for transmitting and receiving radio waves. The BS 6 Controller (BSC) 4 receives the transmissions from one or more BTS's. The BSC 4 provides control and management of the radio transmissions from each BTS 3 by exchanging messages with the BTS and the Mobile Switching Center (MSC) 5 or Internal IP Network. The BTS's 3 and BSC 4 are part of the BS 6 (BS) 6.

The BS 6 exchanges messages with and transmits data to a Circuit Switched Core Network (CSCN) 7 and Packet Switched Core Network (PSCN) 8. The CSCN 7 provides traditional voice communications and the PSCN 8 provides Internet applications and multimedia services.

The Mobile Switching Center (MSC) 5 portion of the CSCN 7 provides switching for traditional voice communications to and from a MS 2 and may store information to support these capabilities. The MSC 2 may be connected to one or more BS's 6 as well as other public networks, for example a Public Switched Telephone Network (PSTN) (not shown) or Integrated Services Digital Network (ISDN) (not shown). A Visitor Location Register (VLR) 9 is used to retrieve information for handling voice communications to or from a visiting subscriber. The VLR 9 may be within the MSC 5 and may serve more than one MSC.

A user identity is assigned to the Home Location Register (HLR) 10 of the CSCN 7 for record purposes such as subscriber information, for example Electronic Serial Number (ESN), Mobile Directory Number (MDR), Profile Information, Current Location, and Authentication Period. The Authentication Center (AC) 11 manages authentication information related to the MS 2. The AC 11 may be within the HLR 10 and may serve more than one HLR. The interface between the MSC 5 and the HLR/AC 10, 11 is an IS-41 standard interface 18.

The Packet data Serving Node (PDSN) 12 portion of the PSCN 8 provides routing for packet data traffic to and from MS 2. The PDSN 12 establishes, maintains, and terminates link layer sessions to the MS 2's 2 and may interface with one or more BS 6 and one or more PSCN 8.

The Authentication, Authorization and Accounting (AAA) 13 Server provides Internet Protocol authentication, authorization and accounting functions related to packet data traffic. The Home Agent (HA) 14 provides authentication of MS 2 IP registrations, redirects packet data to and from the Foreign Agent (FA) 15 component of the PDSN 8, and receives provisioning information for users from the AAA 13. The HA 14 may also establish, maintain, and terminate secure communications to the PDSN 12 and assign a dynamic IP address. The PDSN 12 communicates with the AAA 13, HA 14 and the Internet 16 via an Internal IP Network.

There are several types of multiple access schemes, specifically Frequency Division Multiple Access (FDMA), Time Division Multiple Access (TDMA) and Code Division Multiple Access (CDMA). In FDMA, user communications are separated by frequency, for example, by using 30 KHz channels. In TDMA, user communications are separated by frequency and time, for example, by using 30 KHz channels with 6 timeslots. In CDMA, user communications are separated by digital code.

In CDMA, All users on the same spectrum, for example, 1.25 MHz. Each user has a unique digital code identifier and the digital codes separate users to prevent interference.

A CDMA signal uses many chips to convey a single bit of information. Each user has a unique chip pattern, which is essentially a code channel. In order to recover a bit, a large number of chips are integrated according to a user's known chip pattern. Other user's code patterns appear random and are integrated in a self-canceling manner and, therefore, do not disturb the bit decoding decisions made according to the user's proper code pattern.

Input data is combined with a fast spreading sequence and transmitted as a spread data stream. A receiver uses the same spreading sequence to extract the original data. FIG. 2A illustrates the spreading and de-spreading process. As illustrated in FIG. 2B, multiple spreading sequences may be combined to create unique, robust channels.

A Walsh code is one type of spreading sequence. Each Walsh code is 64 chips long and is precisely orthogonal to all other Walsh codes. The codes are simple to generate and small enough to be stored in read only memory (ROM).

A short PN code is another type of spreading sequence. A short PN code consists of two PN sequences (I and Q), each of which is 32,768 chips long and is generated in similar, but differently tapped 15-bit shift registers. The two sequences scramble the information on the I and Q phase channels.

A long PN code is another type of spreading sequence. A long PN code is generated in a 42-bit register and is more than 40 days long, or about 4×10¹³ chips long. Due to its length, a long PN code cannot be stored in ROM in a terminal and, therefore, is generated chip-by-chip.

Each MS 2 codes its signal with the PN long code and a unique offset, or public long code mask, computed using its unique ESN (Electronic Serial Number) of 32-bits and 10 bits set by the system. The public long code mask produces a unique shift. Private long code masks may be used to enhance privacy. When integrated over as short a period as 64 chips, MS 2 with different long PN code offsets will appear practically orthogonal.

CDMA communication uses forward channels and reverse channels. A forward channel is utilized for signals from a BTS 3 to a MS 2 and a reverse channel is utilized for signals from a MS to a BTS.

A forward channel uses its specific assigned Walsh code and a specific PN offset for a sector, with one user able to have multiple channel types at the same time. A forward channel is identified by its CDMA RF carrier frequency, the unique short code PN offset of the sector and the unique Walsh code of the user. CDMA forward channels include a pilot channel, sync channel, paging channels and traffic channels.

The pilot channel is a “structural beacon” which does not contain a character stream, but rather is a timing sequence used for system acquisition and as a measurement device during handoffs. A pilot channel uses Walsh code 0.

The sync channel carries a data stream of system identification and parameter information used by MS 2 during system acquisition. A sync channel uses Walsh code 32.

There may be from one to seven paging channels according to capacity requirements. Paging channels carry pages, system parameter information and call setup orders. Paging channels use Walsh codes 1-7.

The traffic channels are assigned to individual users to carry call traffic. Traffic channels use any remaining Walsh codes subject to overall capacity as limited by noise.

A reverse channel is utilized for signals from a MS 2 to a BTS 3 and uses a Walsh code and offset of the long PN sequence specific to the MS, with one user able to transmit multiple types of channels simultaneously. A reverse channel is identified by its CDMA RF carrier frequency and the unique long code PN Offset of the individual MS 2. Reverse channels include traffic channels and access channels.

Individual users use traffic channels during actual calls to transmit traffic to the BTS 3. A reverse traffic channel is basically a user-specific Public or Private long code Mask and there are as many reverse traffic channels as there are CDMA terminals.

An MS 2 not yet involved in a call uses access channels to transmit registration requests, call setup requests, page responses, order responses and other signaling information. An access channel is basically a Public long code Offset unique to a BTS 3 sector. Access channels are paired with paging channels, with each paging channel having up to 32 access channels.

CDMA communication provides many advantages. Some of the advantages are variable rate vocoding and multiplexing, forward power control, use of RAKE receivers and soft handoff.

CDMA allows the use of variable rate vocoders to compress speech, reduce bit rate and greatly increase capacity. Variable rate vocoding provides full bit rate during speech, low data rates during speech pauses, increased capacity and natural sound. Multiplexing allows voice, signaling and user secondary data to be mixed in CDMA frames.

By utilizing forward power control, the BTS 3 continually reduces the strength of each user's forward baseband chip stream. When a particular MS 2 experiences errors on the forward link, more energy is requested and a quick boost of energy is supplied after which the energy is again reduced.

Reverse power control uses three methods in tandem to equalize all terminal signal levels at the BTS 3. Reverse open loop power control is characterized by the MS 2 adjusting power up or down based on a received BTS 3 signal (AGC). Reverse closed loop power control is characterized by the BTS 3 adjusting power up or down by 1 db at a rate of 800 times per second. Reverse outer loop power control is characterized by the BSC 4 adjusting a BTS 3 set point when the BSC has forward error correction (FER) trouble hearing the MS 2. FIG. 3 illustrates the three reverse power control methods.

The actual RF power output of the MS 2 transmitter (TXPO), including the combined effects of open loop power control from receiver AGC and closed loop power control by the BTS 3, cannot exceed the maximum power of the MS, which is typically +23 dbm. Reverse power control is performed according to the equation “TXPO=−(RX_{dbm})−C+TXGA,” where “TXGA” is the sum of all closed loop power control commands from the BTS 3 since the beginning of a call and “C” is +73 for 800 MHZ systems and +76 for 1900 MHz systems.

Using a RAKE receiver allows a MS 2 to use the combined outputs of the three or more traffic correlators, or “RAKE fingers,” every frame. Each RAKE finger can independently recover a particular PN Offset and Walsh code. The fingers may be targeted on delayed multipath reflections of different BTS's 3, with a searcher continuously checking pilot signals. FIG. 4 illustrates the use of a RAKE receiver.

The MS 2 drives soft Handoff. The MS 2 continuously checks available pilot signals and reports to the BTS 3 regarding the pilot signals it currently sees. The BTS 3 assigns up to a maximum of six sectors and the MS 2 assigns its fingers accordingly. Air interface (AI) messages are sent by dim-and-burst without muting. Each end of the communication link chooses the best configuration on a frame-by-frame basis, with handoff transparent to users.

A cdma2000 system is a third-generation (3G) wideband; spread spectrum radio interface system that uses the enhanced service potential of CDMA technology to facilitate data capabilities, such as Internet and intranet access, multimedia applications, high-speed business transactions, and telemetry. The focus of cdma2000, as is that of other third-generation systems, is on network economy and radio transmission design to overcome the limitations of a finite amount of radio spectrum availability.

FIG. 4 illustrates a data link protocol architecture layer 20 for a cdma2000 wireless network. The data link protocol architecture layer 20 includes an Upper Layer 60, a Link Layer 30 and a Physical layer 21.

The Upper layer 60 includes three sublayers; a Data Services sublayer 61; a Voice Services sublayer 62 and a Signaling Services sublayer 63. Data services 61 are services that deliver any form of data on behalf of a mobile end user and include packet data applications such as IP service, circuit data applications such as asynchronous fax and B-ISDN emulation services, and SMS. Voice services 62 include PSTN access, mobile-to-mobile voice services, and Internet telephony. Signaling 63 controls all aspects of mobile operation.

The Signaling Services sublayer 63 processes all messages exchanged between the MS 2 and BS 6. These messages control such functions as call setup and teardown, handoffs, feature activation, system configuration, registration and authentication.

In the MS 2, the Signaling Services sublayer 63 is also responsible for maintaining call process states, specifically a MS 2 Initialization State, MS 2 Idle State, System Access State and MS 2 Control on Traffic Channel State.

The Link Layer 30 is subdivided into the Link Access Control (LAC) sublayer 32 and the Medium Access Control (MAC) sublayer 31. The Link Layer 30 provides protocol support and control mechanisms for data transport services and performs the functions necessary to map the data transport needs of the Upper layer 60 into specific capabilities and characteristics of the Physical Layer 21. The Link Layer 30 may be viewed as an interface between the Upper Layer 60 and the Physical Layer 20.

The separation of MAC 31 and LAC 32 sublayers is motivated by the need to support a wide range of Upper Layer 60 services and the requirement to provide for high efficiency and low latency data services over a wide performance range, specifically from 1.2 Kbps to greater than 2 Mbps. Other motivators are the need for supporting high Quality of Service (QoS) delivery of circuit and packet data services, such as limitations on acceptable delays and/or data BER (bit error rate), and the growing demand for advanced multimedia services each service having a different QoS requirements.

The LAC sublayer 32 is required to provide a reliable, in-sequence delivery transmission control function over a point-to-point radio transmission link 42. The LAC sublayer 32 manages point-to point communication channels between upper layer 60 entities and provides framework to support a wide range of different end-to-end reliable Link Layer 30 protocols.

The LAC sublayer 32 provides correct delivery of signaling messages. Functions include assured delivery where acknowledgement is required, unassured delivery where no acknowledgement is required, duplicate message detection, address control to deliver a message to an individual MS 2, segmentation of messages into suitable sized fragments for transfer over the physical medium, reassembly and validation of received messages and global challenge authentication.

The MAC sublayer 31 facilitates complex multimedia, multi-services capabilities of 3G wireless systems with QoS management capabilities for each active service. The MAC sublayer 31 provides procedures for controlling the access of packet data and circuit data services to the Physical Layer 21, including the contention control between multiple services from a single user, as well as between competing users in the wireless system. The MAC sublayer 31 also performs mapping between logical channels and physical channels, multiplexes data from multiple sources onto single physical channels and provides for reasonably reliable transmission over the Radio Link Layer using a Radio Link Protocol (RLP) 33 for a best-effort level of reliability. Signaling Radio Burst Protocol (SRBP) 35 is an entity that provides connectionless protocol for signaling messages. Multiplexing and Qos Control 34 is responsible for enforcement of negotiated QoS levels by mediating conflicting requests from competing services and the appropriate prioritization of access requests.

The Physical Layer 21 is responsible for coding and modulation of data transmitted over the air. The Physical Layer 21 conditions digital data from the higher layers so that the data may be transmitted over a mobile radio channel reliably.

The Physical Layer 21 maps user data and signaling, which the MAC sublayer 31 delivers over multiple transport channels, into a physical channels and transmits the information over the radio interface. In the transmit direction, the functions performed by the Physical Layer 21 include channel coding, interleaving, scrambling, spreading and modulation. In the receive direction, the functions are reversed in order to recover the transmitted data at the receiver.

FIG. 5 illustrates an overview of call processing. Processing a call includes pilot and sync channel processing, paging channel processing, access channel processing and traffic channel processing.

Pilot and sync channel processing refers to the MS 2 processing the pilot and sync channels to acquire and synchronize with the CDMA system in the MS 2 Initialization State. Paging channel processing refers to the MS 2 monitoring the paging channel or the forward common control channel (F-CCCH) to receive overhead and mobile-directed messages from the BS 6 in the Idle State. Access channel processing refers to the MS 2 sending messages to the BS 6 on the access channel or the Enhanced access channel in the System Access State, with the BS 6 always listening to these channels and responding to the MS on either a paging channel or the F-CCCH. Traffic channel processing refers to the BS 6 and MS 2 communicating using dedicated forward and reverse traffic channels in the MS 2 Control on Traffic Channel State, with the dedicated forward and reverse traffic channels carrying user information, such as voice and data.

FIG. 6 illustrates the System Access state. The first step in the system access process is to update overhead information to ensure that the MS 2 is using the correct access channel parameters, such as initial power level and power step increments. A MS 2 randomly selects an access channel and transmits without coordination with the BS 6 or other MS. Such a random access procedure can result in collisions. Several steps can be taken to reduce the likelihood of collision, such as use of a slotted structure, use of a multiple access channel, transmitting at random start times and employing congestion control, for example, overload classes,

The MS 2 may send either a request or a response message on the access channel. A request is a message sent autonomously, such as an Origination message. A response is a message sent in response to a message received from the BS 6. For example, a Page Response message is a response to a General Page message or a Universal message.

The Multiplexing and QoS Control sublayer 34 has both a transmitting function and a receiving function. The transmitting function combines information from various sources, such as Data Services 61, Signaling Services 63 or Voice Services 62, and forms Physical layer SDUs and PDCHCF SDUs for transmission. The receiving function separates the information contained in Physical Layer 21 and PDCHCF SDUs and directs the information to the correct entity, such as Data Services 61, Upper Layer Signaling 63 or Voice Services 62.

The Multiplexing and QoS Control sublayer 34 operates in time synchronization with the Physical Layer 21. If the Physical Layer 21 is transmitting with a non-zero frame offset, the Multiplexing and QoS Control sublayer 34 delivers Physical Layer SDUs for transmission by the Physical Layer at the appropriate frame offset from system time.

The Multiplexing and QoS Control sublayer 34 delivers a Physical Layer 21 SDU to the Physical Layer using a physical-channel specific service interface set of primitives. The Physical Layer 21 delivers a Physical Layer SDU to the Multiplexing and QoS Control sublayer 34 using a physical channel specific Receive Indication service interface operation.

The SRBP Sublayer 35 includes the sync channel, forward common control channel, broadcast control channel, paging channel and access channel procedures.

The LAC Sublayer 32 provides services to Layer 3 60. SDUs are passed between Layer 3 60 and the LAC Sublayer 32. The LAC Sublayer 32 provides the proper encapsulation of the SDUs into LAC PDUs, which are subject to segmentation and reassembly and are transferred as encapsulated PDU fragments to the MAC Sublayer 31.

Processing within the LAC Sublayer 32 is done sequentially, with processing entities passing the partially formed LAC PDU to each other in a well-established order. SDUs and PDUs are processed and transferred along functional paths, without the need for the upper layers to be aware of the radio characteristics of the physical channels. However, the upper layers could be aware of the characteristics of the physical channels and may direct Layer 2 30 to use certain physical channels for the transmission of certain PDUs.

A 1×EV-DO system is optimized for packet data service and characterized by a single 1.25 MHz carrier (“1×”) for data only or data Optimized (“DO”). Furthermore, there is a peak data rate of up to 4.9152 Mbps on the forward Link and up to 1.8432 Mbps on the reverse Link. Moreover, a 1×EV-DO system provides separated frequency bands and internetworking with a 1× System. FIG. 7 illustrates a comparison of cdma2000 for 1× and 1×EV-DO.

In a cdma2000 system, there are concurrent services, whereby voice and data are transmitted together at a maximum data rate of 614.4 kbps and 307.2 kbps in practice. An MS 2 communicates with the MSC 5 for voice calls and with the PDSN 12 for data calls. A cdma2000 system is characterized by a fixed rate with variable power with a Walsh-code separated forward traffic channel.

In a 1×EV-DO system, the maximum data rate is 4.9152 Mbps and there is no communication with the circuit-switched core network 7. A 1×EV-DO system is characterized by fixed power and a variable rate with a single forward channel that is time division multiplexed.

FIG. 8 illustrates a 1×EV-DO system architecture. In a 1×EV-DO system, a frame consists of 16 slots, with 600 slots/sec, and has a duration of 26.67 ms, or 32,768 chips. A single slot is 1.6667 ms long and has 2048 chips. A control/traffic channel has 1600 chips in a slot, a pilot channel has 192 chips in a slot and a MAC channel has 256 chips in a slot. A 1×EV-DO system facilitates simpler and faster channel estimation and time synchronization,

FIG. 9 illustrates a 1×EV-DO system default protocol architecture. FIG. 10 illustrates a 1×EV-DO system non-default protocol architecture.

Information related to a session in a 1×EV-DO system includes a set of protocols used by an MS 2, or access terminal (AT), and a BS 6, or access network (AN), over an airlink, a Unicast Access Terminal Identifier (UATI), configuration of the protocols used by the AT and AN over the airlink and an estimate of the current AT location.

The Application Layer provides best effort, whereby the message is sent once, and reliable delivery, whereby the message can be retransmitted one or more times. The Stream Layer provides the ability to multiplex up to 4 (default) or 255 (non-default) application streams for one AT 2.

The Session Layer ensures the session is still valid and manages closing of a session, specifies procedures for the initial UATI assignment, maintains AT addresses and negotiates/provisions the protocols used during the session and the configuration parameters for these protocols.

FIG. 11 illustrates the establishment of a 1×EV-DO session. As illustrated in FIG. 11, establishing a session includes address configuration, connection establishment, session configuration and exchange keys.

Address configuration refers to an Address Management protocol assigning a UATI and Subnet mask. Connection establishment refers to Connection Layer protocols setting up a radio link. Session configuration refers to a Session Configuration Protocol configuring all protocols. Exchange keys refers to a Key Exchange protocol in the Security Layer setting up keys for authentication.

A ‘session’ refers to the logical communication link between the AT 2 and the RNC, which remains open for hours, with a default of 54 hours. A session lasts until the PPP session is active as well. Session information is controlled and maintained by the RNC in the AN 6.

When a connection is opened, the AT 2 can be assigned the forward traffic channel and is assigned a reverse traffic channel and reverse power control channel. Multiple connections may occur during single session. There are two connection states in a 1×EV-DO system, a closed connection and an Open connection.

A closed connection refers to a state where the AT 2 is not assigned any dedicated air-link resources and communications between the AT and AN 6 are conducted over the access channel and the control channel. An open connection refers to a state where the AT 2 can be assigned the forward traffic channel, is assigned a reverse power control channel and a reverse traffic channel and communication between the AT 2 and AN 6 is conducted over these assigned channels as well as over the control channel.

The Connection Layer manages initial acquisition of the network, setting an open connection and closed connection and communications. Furthermore, the Connection Layer maintains an approximate AT 2 location in both the open connection and closed connection and manages a radio link between the AT 2 and the AN 6 when there is an open connection.

FIG. 12 illustrates Connection Layer Protocols. As illustrated in FIG. 12, the protocols include an Initialization State, an Idle State and a Connected State.

In the Initialization State, the AT 2 acquires the AN 6 and activates the initialization State Protocol. In the Idle State, a closed connection is initiated and the Idle State Protocol is activated. In the connected State, an open connection is initiated and the Connected State Protocol is activated.

The Initialization State Protocol performs actions associated with acquiring an AN 6. The Idle State Protocol performs actions associated with an AT 2 that has acquired an AN 6, but does not have an open connection, such as keeping track of the AT location using a Route Update Protocol. The Connected State Protocol performs actions associated with an AT 2 that has an open connection, such as managing the radio link between the AT and AN 6 and managing the procedures leading to a closed connection. The Route Update Protocol performs actions associated with keeping track of the AT 2 location and maintaining the radio link between the AT and AN 6. The Overhead message Protocol broadcasts essential parameters, such as QuickConfig, SectorParameters and AccessParameters message, over the control channel. The Packet Consolidation Protocol consolidates and prioritizes packets for transmission as a function of their assigned priority and the target channel as well as providing packet de-multiplexing on the receiver.

The Security Layer includes a key exchange function, authentication function and encryption function. The key exchange function provides the procedures followed by the AN 2 and AT 6 for authenticating traffic. The authentication function provides the procedures followed by the AN 2 and AT 6 to exchange security keys for authentication and encryption. The encryption function provides the procedures followed by the AN 2 and AT 6 for encrypting traffic.

The 1×EV-DO forward link is characterized in that no power control and no soft handoff is supported. The AN 6 transmits at constant power and the AT 2 requests variable rates on the forward Link. Because different users may transmit at different times in TDM, it is difficult to implement diversity transmission from different BS's 6 that are intended for a single user.

The AN 6 uses the reverse power control (RPC) channel for power control of the AT's 2 reverse link transmissions. A reverse power control Bit is transmitted through the RPC channel, with a data rate of 600 (1-1/DRCLockPeriod) bps or 150 bps.

The 1×EV-DO reverse link is characterized in that the AN 6 can power control the reverse Link by using reverse power control and more than one AN can receive the AT's 2 transmission via soft handoff. Furthermore, there is no TDM on the reverse Link, which is channelized by Walsh code using a long PN code.

Determining the transmission power of a mobile terminal adds overhead. One conventional method to reduce the overhead of transmission power determination is for the mobile terminal to report its transmission power periodically to the network. Another conventional method to reduce overhead of transmission power determination is for the mobile terminal to report the actual transmission power along with power headroom information, or the leftover transmission power at the mobile, that is already reported to the network.

For example, the power headroom information is reported in a Request Message and/or Route Update Message. In order to reduce overhead, the mobile terminal may transmit the actual transmission power along with the power headroom information in the Request Message and/or Route Update Message. However, if the access network (AN) 6 already had knowledge of the maximum transmission power of the AT 2, overhead could be reduced further.

Therefore, there is a need for a more efficient means to report power related information to a network in order to reduce overhead related to determining the transmission power of a mobile terminal. The present invention addresses this and other needs.

### SUMMARY OF THE INVENTION

Features and advantages of the invention will be set forth in the description which follows, and in part will be apparent from the description, or may be learned by practice of the invention. The objectives and other advantages of the invention will be realized and attained by the structure particularly pointed out in the written description and claims hereof as well as the appended drawings. The invention is directed to provide a method and apparatus to enable a network to more efficiently determine the transmission power of a mobile terminal.

In one aspect of the present invention, a method of assigning channels in a multi-carrier mobile communication system is provided. The method includes transmitting first information to a network upon initiation of a communication session, the first information indicating a first power-related parameter of a mobile communication terminal, transmitting second information to the network periodically, the second information indicating a second power-related parameter of the mobile communication terminal and determining whether an additional channel is assigned based on the first and second information.

It is contemplated that the determination is related to assigning an additional reverse link channel. It is further contemplated that the first information includes either a maximum transmission power of the mobile communication terminal, a power class of the mobile communication terminal or a maximum power headroom of the mobile communication terminal.

It is contemplated that the second information includes either a currently allocated transmission power of the mobile communication terminal, a pilot transmission power of the mobile communication terminal or a currently available leftover power of the mobile communication terminal. It is further contemplated that the method further includes determining either a reverse link control/feedback channel power or a traffic channel power of the mobile communication terminal according to a pilot channel power of the mobile communication terminal and a ratio of the pilot channel power to the one of the reverse link control/feedback channel power and the traffic channel power. Preferably, the reverse link control/feedback channel power is either data rate control channel power or data source control channel power.

It is contemplated that the method further includes determining the currently allocated transmission power according to at least one of the pilot power, the reverse link control/feedback channel power and the traffic channel power of the mobile communication terminal. It is further contemplated that determining whether an additional channel is assigned includes determining third information indicating a third power-related parameter based on the first and second information. Preferably, the reverse link control/feedback channel power is either data rate control channel power or data source control channel power.

In another aspect of the present invention, a method of assigning reverse link channels in a multi-carrier mobile communication system is provided. The method includes transmitting first information to a network upon initialization of a communication session, the first information indicating a maximum transmission power of a mobile communication terminal, a power class of the mobile communication terminal or a maximum power headroom of the mobile communication terminal, transmitting second information to a network periodically, the second information indicating a current transmission power of the mobile communication terminal or a currently available leftover power of the mobile communication terminal and determining whether an additional reverse channel is assigned based on the first and second information.

In another aspect of the present invention, a method of assigning reverse link channels in a multi-carrier mobile communication system is provided. The method includes transmitting first information to a network upon initialization of a communication session, the first information indicating a maximum transmission power of a mobile communication terminal, a power class of the mobile communication terminal or a maximum power headroom of the mobile communication terminal, transmitting second information to a network periodically, the second information including one of a currently allocated transmission power of the mobile communication terminal, a pilot transmission power of the mobile communication terminal and a currently available leftover power of the mobile communication terminal and determining whether an additional reverse channel is assigned based on the first and second information. Preferably, the second information indicates either a difference between a maximum transmission power of the mobile communication terminal and a pilot channel power or a ratio of the pilot channel power to one of a data rate control channel power, a data source control channel power, and a traffic channel power.

In another aspect of the present invention, a mobile terminal adapted for use in a multi-carrier mobile communication system is provided. The mobile terminal includes a transmitting/receiving unit adapted to transmit first information and second information to a network, a display unit adapted to display user interface information, an input unit adapted to input user data and a processing unit adapted to generate the first information indicating a first power-related parameter of the mobile communication terminal and the second information indicating a second power-related parameter of the mobile communication terminal and to control the transmitting/receiving unit to transmit the first information to a network upon initiation of a communication session and to transmit the second information to the network periodically such that whether an additional channel is assigned is determined based on the first and second information.

It is contemplated that the determination is related to assigning an additional reverse link channel. It is further contemplated that the first information includes a maximum transmission power of the mobile communication terminal, a power class of the mobile communication terminal or a maximum power headroom of the mobile communication terminal.

It is contemplated that the second information includes a currently allocated transmission power of the mobile communication terminal, a pilot transmission power of the mobile communication terminal or a currently available leftover power of the mobile communication terminal. It is further contemplated that the control unit is further adapted to generate the first and second information such that one of a data rate control channel power, a data source control channel power and a traffic channel power of the mobile communication terminal is determined according to a pilot channel power of the mobile communication terminal and a ratio of the pilot channel power to one of the data rate control channel power, the data source control channel power and the traffic channel power.

It is contemplated that the control unit is further adapted to generate the first and second information such that the currently allocated transmission power is determined according to at least one of the data rate control channel power, the data source control channel power and the traffic channel power of the mobile communication terminal. It is further contemplated that the control unit is further adapted to generate the first and second information such that whether an additional channel is assigned is determined by determining third information indicating a third power-related parameter based on the first and second information.

It is contemplated that the control unit is further adapted to generate the first information indicating a maximum transmission power of the mobile communication terminal, a power class of the mobile communication terminal or a maximum power headroom of the mobile communication terminal and generate the second information indicating a current transmission power of the mobile communication terminal or a currently available leftover power of the mobile communication terminal. It is further contemplated that the control unit is further adapted to generate the first information indicating a maximum transmission power of the mobile communication terminal, a power class of the mobile communication terminal or a maximum power headroom of the mobile communication terminal and generate the second information indicating either a difference between a maximum transmission power of the mobile communication terminal and a pilot channel power or a ratio of the pilot channel power to one of a data rate control channel power, a data source control channel power and a traffic channel power.

Additional features and advantages of the invention will be set forth in the description which follows, and in part will be apparent from the description, or may be learned by practice of the invention. It is to be understood that both the foregoing general description and the following detailed description of the present invention are exemplary and explanatory and are intended to provide further explanation of the invention as claimed.

These and other embodiments will also become readily apparent to those skilled in the art from the following detailed description of the embodiments having reference to the attached figures, the invention not being limited to any particular embodiments disclosed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention. Features, elements, and aspects of the invention that are referenced by the same numerals in different figures represent the same, equivalent, or similar features, elements, or aspects in accordance with one or more embodiments.

FIG. 1 illustrates wireless communication network architecture.

FIG. 2A illustrates a CDMA spreading and de-spreading process.

FIG. 2B illustrates a CDMA spreading and de-spreading process using multiple spreading sequences.

FIG. 3 illustrates CDMA reverse power control methods.

FIG. 4 illustrates a data link protocol architecture layer for a cdma2000wireless network.

FIG. 5 illustrates cdma2000 call processing.

FIG. 6 illustrates the cdma2000 system access state.

FIG. 7 illustrates a comparison of cdma2000 for 1× and 1×EV-DO.

FIG. 8 illustrates a network architecture layer for a 1×EV-DO wireless network.

FIG. 9 illustrates 1×EV-DO default protocol architecture.

FIG. 10 illustrates 1×EV-DO non-default protocol architecture.

FIG. 11 illustrates 1×EV-DO session establishment.

FIG. 12 illustrates 1×EV-DO connection layer protocols.

FIG. 13 illustrates a method for determining transmission power of a mobile terminal according to one embodiment of the present invention.

FIG. 14 illustrates a block diagram of a mobile station or access terminal.

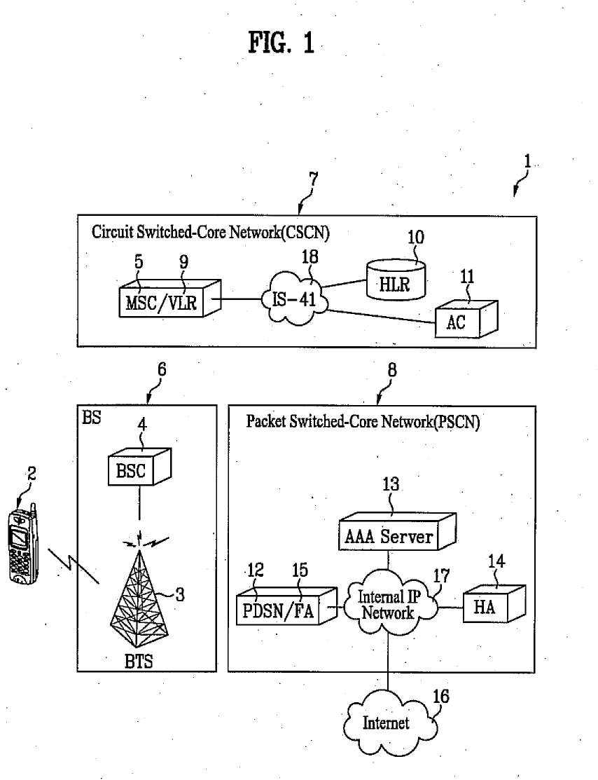

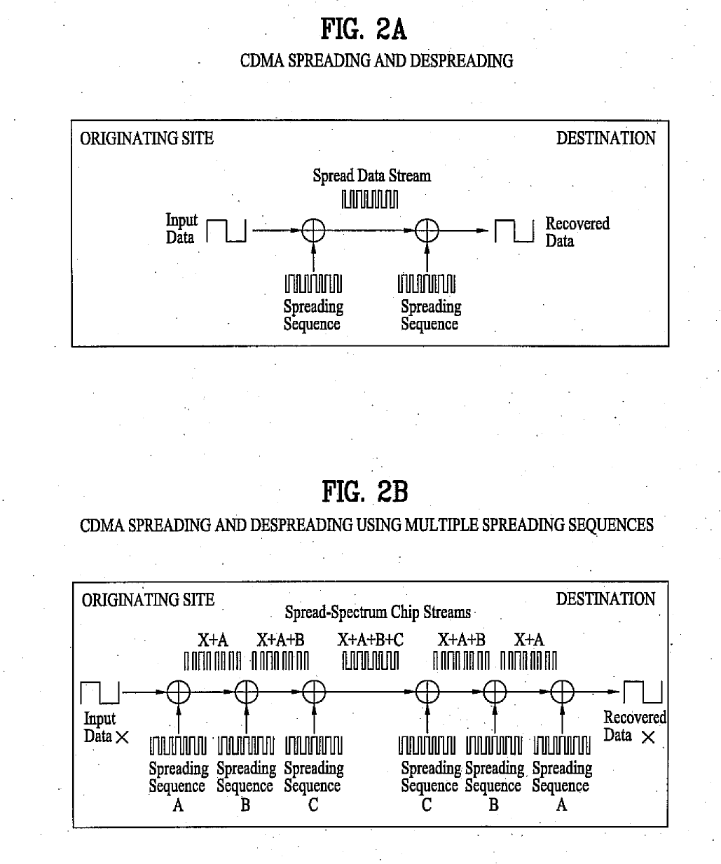

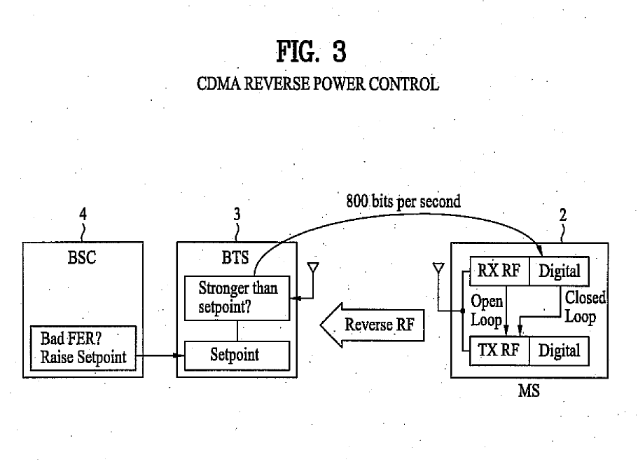

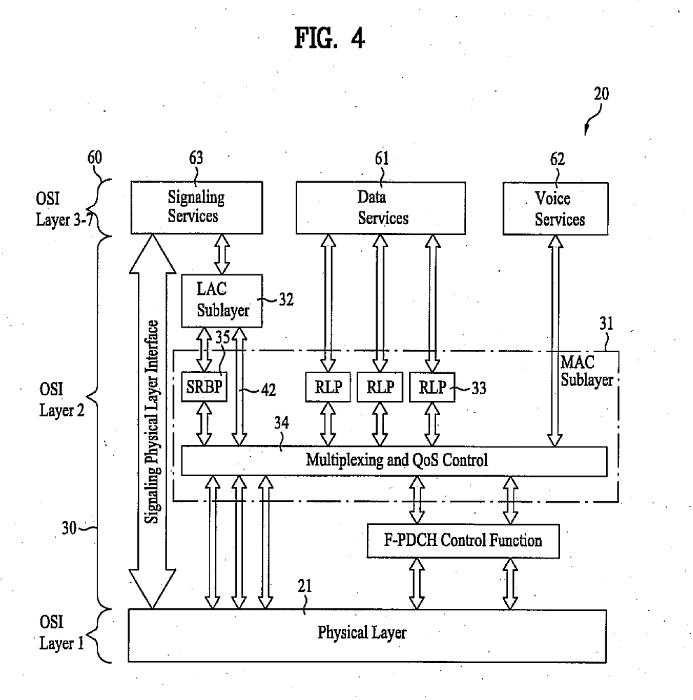

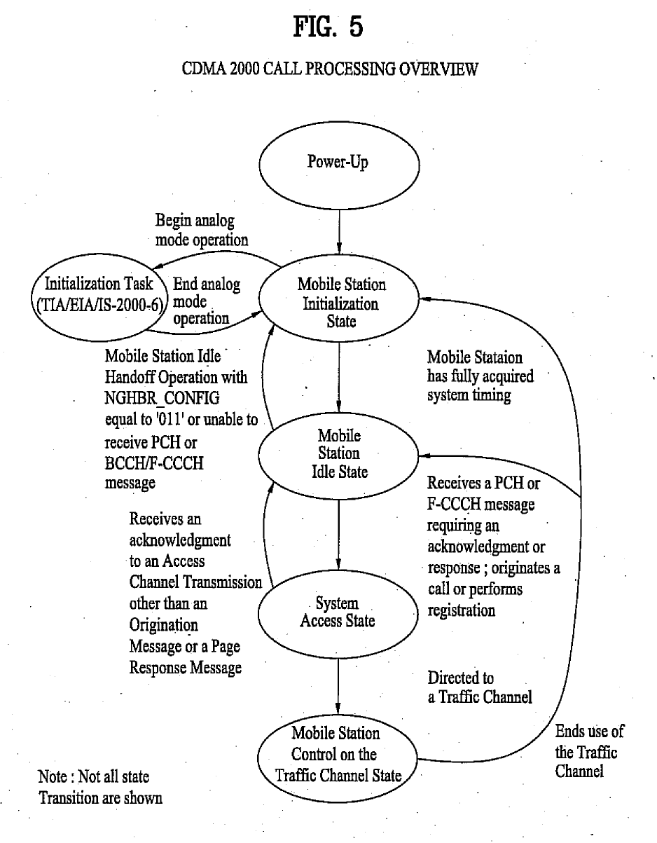

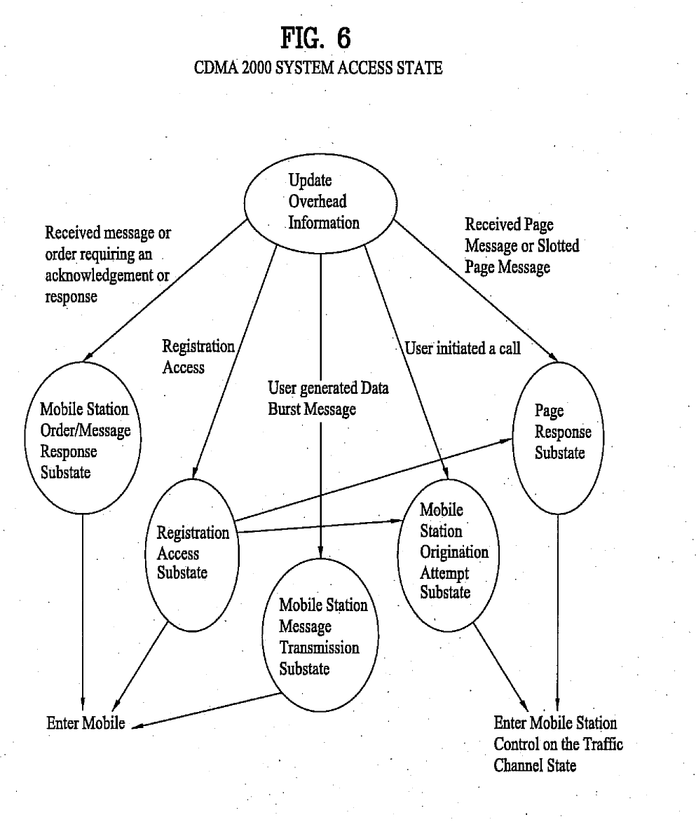

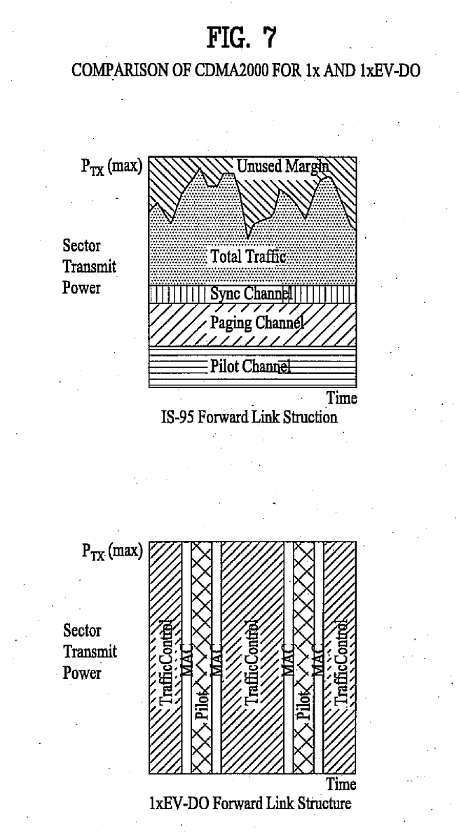

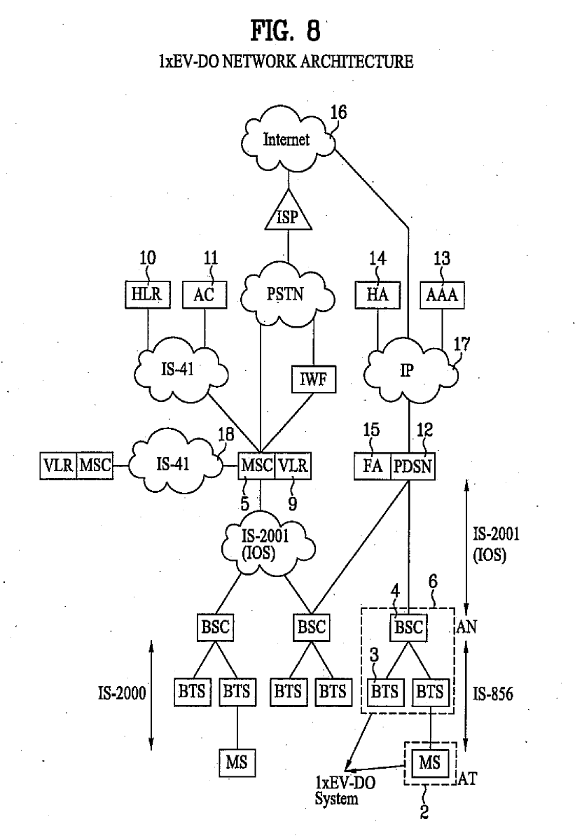

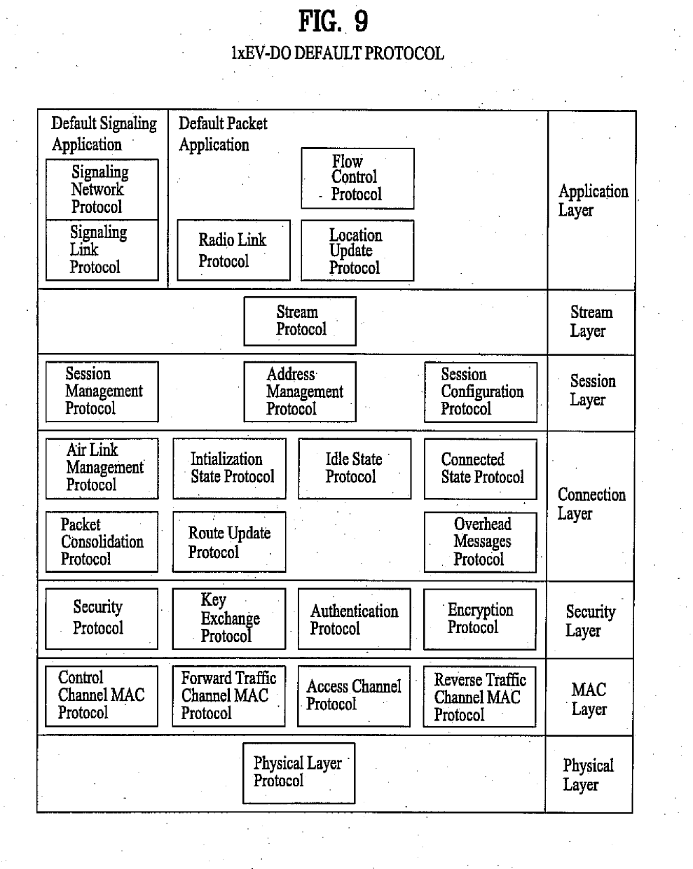

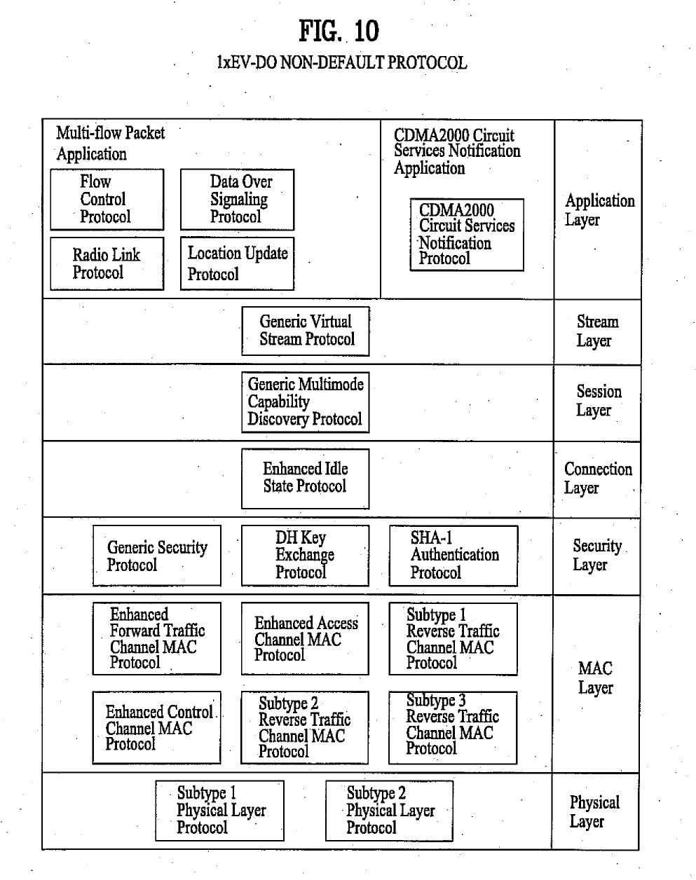

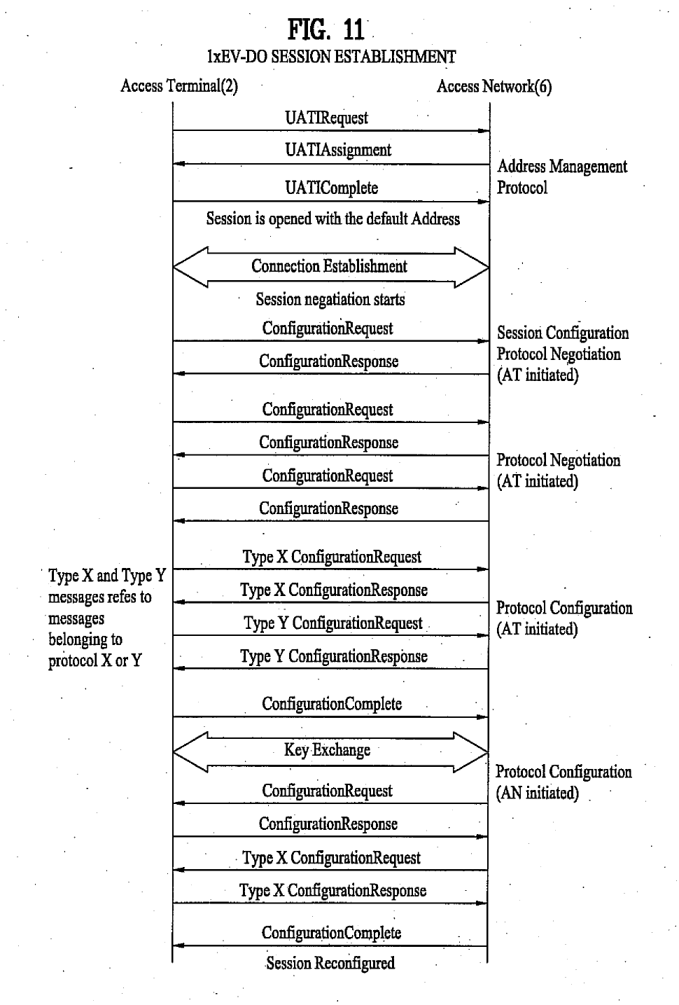

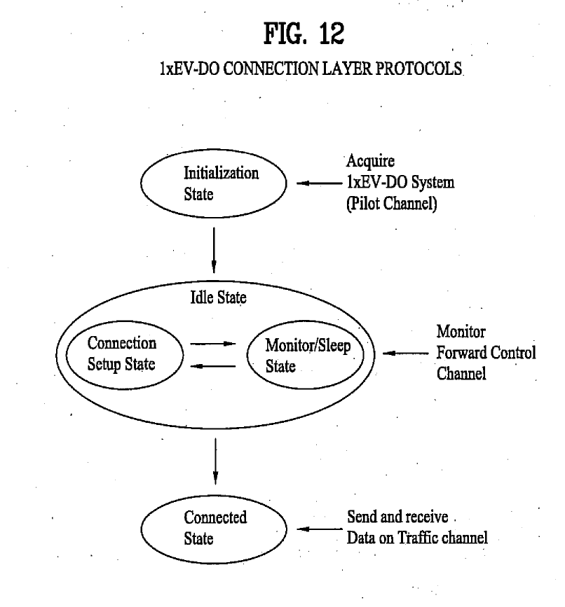

### DETAILED DESCRIPTION OF THE PREFERRED EMBODIMENTS

The present invention relates to a method and apparatus to facilitate more efficient determination of the transmission power of a mobile terminal. Although the present invention is illustrated with respect to a mobile terminal, it is contemplated that the present invention may be utilized anytime it is desired to facilitate more efficient determination of the transmission power of communication devices.

Power headroom is calculated based on the maximum power and the current pilot power. Once the power headroom and current pilot power are known, the number of additional carriers may be calculated.

By having the AT 2 initially report its maximum transmission power at session setup, the AN 6 can calculate the actual transmission power of the AT based upon the difference between the maximum transmission power and the power headroom information.

The present invention may be applied for any multi-carrier system where it may be necessary to estimate the transmission power per carrier. For example, the methods of the present invention may be utilized to determine if an extra RL can be assigned and supported by the AT 2.

In one embodiment of the present invention, the AT 2 reports its power class, which corresponds to the maximum transmission power of the terminal, instead of the actual maximum transmission power. The power class information and some other indicator, such as power headroom, would allow calculation of an actual transmission power. In another embodiment of the present invention, the AT 2 reports its maximum power headroom information instead of the actual maximum transmission power.

The power headroom information may also be represented by the difference between the maximum power and pilot power, which may be expressed in terms of ratios or dB. If the pilot to DRC (Data Rate Control), pilot to DSC (Data Source Control) or pilot to traffic ratio is known, the AN 6 can calculate the actual leftover power of the AT 2. In this way, even if the power headroom is be defined slightly differently, such as in terms of pilot power as the reference instead, the transmission power of the AT 2 may still be calculated.

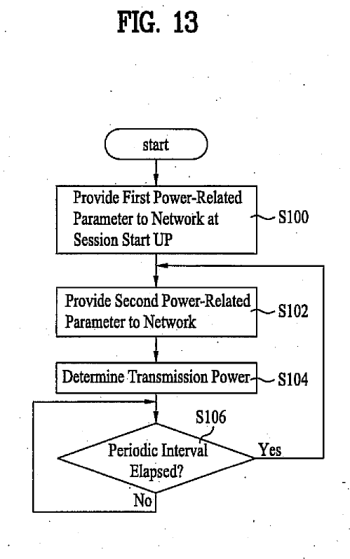

FIG. 13 illustrates a method for determining the transmission power of a mobile terminal according to one embodiment of the present invention. In step S100, a first power-related parameter is provided to a network at session start up. In step S102 a second power-related parameter is provided to the network. At step S104, the transmission power of the mobile terminal is determined based on the first and second parameters. At step S106, a predetermined periodic interval is utilized to periodically provide the second power-related parameter to the network.

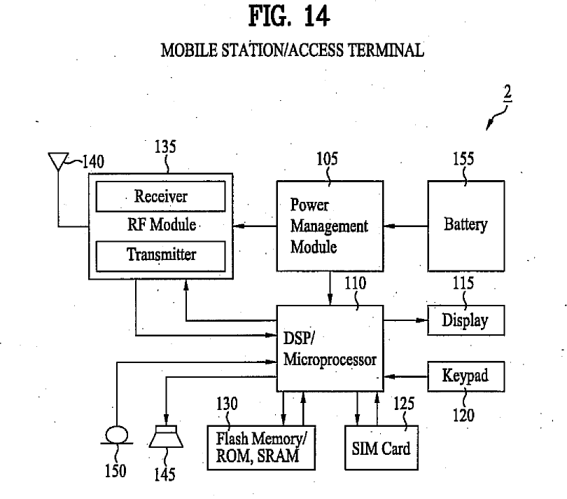

FIG. 14 illustrates a block diagram of a mobile station (MS) or Access Terminal 2. The AT 2 includes a processor (or digital signal processor) 110, RF module 135, power management module 105, antenna 140, battery 155, display 115, keypad 120, memory 130, SIM card 125 (which may be optional), speaker 145 and microphone 150.

A user enters instructional information, such as a telephone number, for example, by pushing the buttons of a keypad 120 or by voice activation using the microphone 150. The microprocessor 110 receives and processes the instructional information to perform the appropriate function, such as to dial the telephone number. Operational data may be retrieved from the Subscriber Identity Module (SIM) card 125 or the memory module 130 to perform the function. Furthermore, the processor 110 may display the instructional and operational information on the display 115 for the user's reference and convenience.

The processor 110 issues instructional information to the RF module 135, to initiate communication, for example, transmit radio signals comprising voice communication data. The RF module 135 includes a receiver and a transmitter to receive and transmit radio signals. An antenna 140 facilitates the transmission and reception of radio signals. Upon receiving radio signals, the RF module 135 may forward and convert the signals to baseband frequency for processing by the processor 110. The processed signals would be transformed into audible or readable information outputted via the speaker 145, for example. The processor 110 also includes the protocols and functions necessary to perform the various processes described herein with regard to cdma2000 or 1×EV-DO systems.

The processor 110 is adapted to perform the method disclosed herein for determination of the transmission power of a mobile terminal. The processor 110 generates the power-related parameters and controls the RF module 135 to transmit the power-related parameters to a network at session start up.

As the present invention may be embodied in several forms without departing from the spirit or essential characteristics thereof it should also be understood that the above-described embodiments are not limited by any of the details of the foregoing description, unless otherwise specified, but rather should be construed broadly within its spirit and scope as defined in the appended claims, and therefore all changes and modifications that fall within the metes and bounds of the claims, or equivalence of such metes and bounds are therefore intended to be embraced by the appended claims.

The foregoing embodiments and advantages are merely exemplary and are not to be construed as limiting the present invention. The present teaching can be readily applied to other types of apparatuses. The description of the present invention is intended to be illustrative, and not to limit the scope of the claims. Many alternatives, modifications, and variations will be apparent to those skilled in the art. In the claims, means-plus-function clauses are intended to cover the structure described herein as performing the recited function and not only structural equivalents but also equivalent structures.

What is claimed is:

1. A method of assigning channels in a multi-carrier mobile communication system, the method comprising:
transmitting first information to a network upon initiation of a communication session, the first information indicating a first power-related parameter of a mobile communication terminal;
transmitting second information to the network periodically, the second information indicating a second power-related parameter of the mobile communication terminal; and
determining whether an additional channel is assigned based on the first and second information.

2. The method of claim 1, wherein the determination is related to assigning an additional reverse link channel.

3. The method of claim 1, wherein the first information comprises one of a maximum transmission power of the mobile communication terminal, a power class of the mobile communication terminal and a maximum power headroom of the mobile communication terminal.

4. The method of claim 3, wherein the second information comprises one of a currently allocated transmission power of the mobile communication terminal, a pilot transmission power of the mobile communication terminal and a currently available leftover power of the mobile communication terminal.

5. The method of claim 4, further comprising determining one of a reverse link control/feedback channel power and a traffic channel power of the mobile communication terminal according to a pilot channel power of the mobile communication terminal and a ratio of the pilot channel power to the one of the reverse link control/feedback channel power and the traffic channel power.

6. The method of claim 5, wherein the reverse link control/feedback channel power comprises one of data rate control channel power and data source control channel power.

7. The method of claim 5, further comprising determining the currently allocated transmission power according to at least one of the pilot power, the reverse link control/feedback channel power and the traffic channel power of the mobile communication terminal.

8. The method of claim 7, wherein the reverse link control/feedback channel power comprises one of data rate control channel power and data source control channel power.

9. The method of claim 1, wherein determining whether an additional channel is assigned comprises determining third information indicating a third power-related parameter based on the first and second information.

10. A method of assigning reverse link channels in a multi-carrier mobile communication system, the method comprising:
transmitting first information to a network upon initialization of a communication session, the first information indicating one of a maximum transmission power of a mobile communication terminal, a power class of the mobile communication terminal and a maximum power headroom of the mobile communication terminal;
transmitting second information to a network periodically, the second information indicating one of a current transmission power of the mobile communication terminal and a currently available leftover power of the mobile communication terminal; and
determining whether an additional reverse channel is assigned based on the first and second information.

11. A method of assigning reverse link channels in a multi-carrier mobile communication system, the method comprising:
transmitting first information to a network upon initialization of a communication session, the first information indicating one of a maximum transmission power of a mobile communication terminal, a power class of the mobile communication terminal and a maximum power headroom of the mobile communication terminal;
transmitting second information to a network periodically, the second information comprising one of a currently allocated transmission power of the mobile communication terminal, a pilot transmission power of the mobile communication terminal and a currently available leftover power of the mobile communication terminal; and
determining whether an additional reverse channel is assigned based on the first and second information.

12. The method of claim 11, wherein the second information indicates either a difference between a maximum transmission power of the mobile communication terminal and a pilot channel power or a ratio of the pilot channel power to one of a data rate control channel power, a data source control channel power, and a traffic channel power.

13. A mobile terminal adapted for use in a multi-carrier mobile communication system, the mobile terminal comprising:
a transmitting/receiving unit adapted to transmit first information and second information to a network;
a display unit adapted to display user interface information;
an input unit adapted to input user data; and
a processing unit adapted to generate the first information indicating a first power-related parameter of the mobile communication terminal and the second information indicating a second power-related parameter of the mobile communication terminal and to control the transmitting/receiving unit to transmit the first information to a network upon initiation of a communication session and to transmit the second information to the network periodically such that whether an additional channel is assigned is determined based on the first and second information.

14. The terminal of claim 13, wherein the determination is related to assigning an additional reverse link channel.

15. The terminal of claim 13, wherein the first information comprises one of a maximum transmission power of the mobile communication terminal, a power class of the mobile communication terminal and a maximum power headroom of the mobile communication terminal.

16. The terminal of claim 13, wherein the second information comprises one of a currently allocated transmission power of the mobile communication terminal, a pilot transmission power of the mobile communication terminal and a currently available leftover power of the mobile communication terminal.

17. The terminal of claim 16, wherein the control unit is further adapted to generate the first and second information such that one of a data rate control channel power, a data source control channel power and a traffic channel power of the mobile communication terminal is determined according to a pilot channel power of the mobile communication terminal and a ratio of the pilot channel power to one of the data rate control channel power, the data source control channel power and the traffic channel power.

18. The terminal of claim 17, wherein the control unit is further adapted to generate the first and second information such that the currently allocated transmission power is determined according to at least one of the data rate control channel power, the data source control channel power and the traffic channel power of the mobile communication terminal.

19. The terminal of claim 13, wherein the control unit is further adapted to generate the first and second information such that whether an additional channel is assigned is determined by determining third information indicating a third power-related parameter based on the first and second information.

20. The terminal of claim 13, wherein the control unit is further adapted to:
generate the first information indicating one of a maximum transmission power of the mobile communication terminal, a power class of the mobile communication terminal and a maximum power headroom of the mobile communication terminal; and
generate the second information indicating one of a current transmission power of the mobile communication terminal and a currently available leftover power of the mobile communication terminal.

21. The terminal of claim 13, wherein the control unit is further adapted to
generate the first information indicating one of a maximum transmission power of the mobile communication terminal, a power class of the mobile communication terminal and a maximum power headroom of the mobile communication terminal; and
generate the second information indicating either a difference between a maximum transmission power of the mobile communication terminal and a pilot channel power or a ratio of the pilot channel power to one of a data rate control channel power, a data source control channel power and a traffic channel power.
